(19) United States
(12) Patent Application Publication
(10) Pub. No.: US 2005/0030197 A1
(43) Pub. Date: Feb. 10, 2005

(54) control system and method for automotive decorative lighting

(76) Inventors: Thomas A. Greenacre, Aurora, IL (US); Kenneth D. Neltnor, Geneva, IL (US)

Correspondence Address: J. Terry Stratman;Seyfarth Shaw, Suite 4200, 55 East Monroe Street, Chicago, IL, 60603-5803, US

(21) Appl. No.: 10/635,266

(22) Filed: Aug. 6, 2003

(51) Int. Cl. G08C 19/00

(52) U.S. Cl. 340/825.72

(57) ABSTRACT

A system for controlling a device on a vehicle with an onboard battery and circuitry delivering battery voltage to plural remote onboard locations at which battery voltage is accessible, includes a portable wireless remote control unit including circuitry for generating and transmitting wireless control signals, and a portable wireless receiving unit for receiving wireless control signals and generating output signals, the receiving unit including power input lead adapted to be connected to battery voltage at any of the remote locations on the vehicle and a control output lead for connecting the output signals to an associated apparatus to be controlled. The remote control unit may be powered by its own battery or by the vehicle battery as through a cigarette lighter.

### BACKGROUND

This application relates to decorative lighting of the type used in automotive vehicles and the like and, in particular, to techniques for connecting and controlling such lighting systems.

A number of different lighting products and systems are currently available which are used to accent or decorate the interior or exterior of an automobile or other automotive vehicle. Such lighting systems may be used at various locations on a vehicle, such as under the dash, under seats, in the engine compartment, on speaker boxes, around window frames, on license plate frames, or almost anywhere else on the interior or exterior of a vehicle. Such lighting systems frequently include neon lights, but could utilize any type of lighting lamps.

To operate such lights or light systems, a connection to the vehicle onboard battery is required. A typical installation might be under the front edge of the vehicle back seat. Once the lights or lighting system is mounted in the vehicle, a connecting wire is routed to a switch which is, in turn, connected to the vehicle onboard battery, the switch typically being mounted at the front of the passenger compartment, such as on the dashboard, for easy access and control by the driver. The routing of the wires may be under the vehicle carpeting. The wire routing may be more complicated for lighting systems disposed at other locations on the vehicle.

The installation of the control switch or switches, the routing of the wires from each light or light system to the switches, and the actual wiring of the switches to the vehicle onboard battery can be a very difficult and time-consuming operation. Furthermore, if not done properly, it may result in a safety hazard. If additional lights are later added, wires must be routed to an additional switch or switches.

### SUMMARY

There is disclosed in this application an improved control system and method for automotive decorative lighting which avoids the disadvantages of prior techniques while affording additional structural and operating advantages.

A control system for a vehicle accessory apparatus is disclosed which eliminates the need for wiring apparatus to a central control switch, mounting the switch on the vehicle and wiring the switch to the vehicle battery.

The system includes a remote control unit which is portable and permits control of the lighting system or other controlled device from inside or outside the vehicle.

The system includes a single controller which is capable of controlling multiple lights or lighting systems.

In particular, there is provided a control system for use with a vehicle having an onboard battery and circuitry delivering battery voltage to plural remote onboard locations at which battery voltage is accessible, the system comprising a portable wireless remote control unit including circuitry for generating and transmitting wireless control signals, and a portable wireless receiving unit for receiving wireless control signals and generating output signals, the receiving unit including a power input lead adapted to be connected to battery voltage at any of the remote locations on the vehicle and a control output lead for connecting the output signals to an associated apparatus to be controlled.

There is also provided a method of controlling a decorative accessory lighting system on a vehicle of the type set forth, the method comprising providing a portable wireless remote control transmitting unit and a portable wireless receiving unit, connecting the receiving unit to battery voltage at an access location on the vehicle close to that at which the accessory lighting system is to be disposed, connecting the receiving unit to the accessory lighting system, and transmitting wireless control signals from the transmitting unit to the receiving unit.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a diagrammatic side elevational view, partially broken away, of an automotive vehicle incorporating a decorative lighting system and a control system for controlling the lighting system;

FIG. 2 is a top plan view of an embodiment of the control system of FIG. 1;

FIG. 3 is a functional block diagram of the transmitter of the control system of FIG. 1;

FIG. 4 is a functional block diagram of the receiver of the control system of FIG. 1;

FIG. 5 is a block diagram of an alternate form of the transmitter of FIG. 3; and

FIG. 6 is a block diagram of an alternate form of the receiver of FIG. 4.

### DETAILED DESCRIPTION

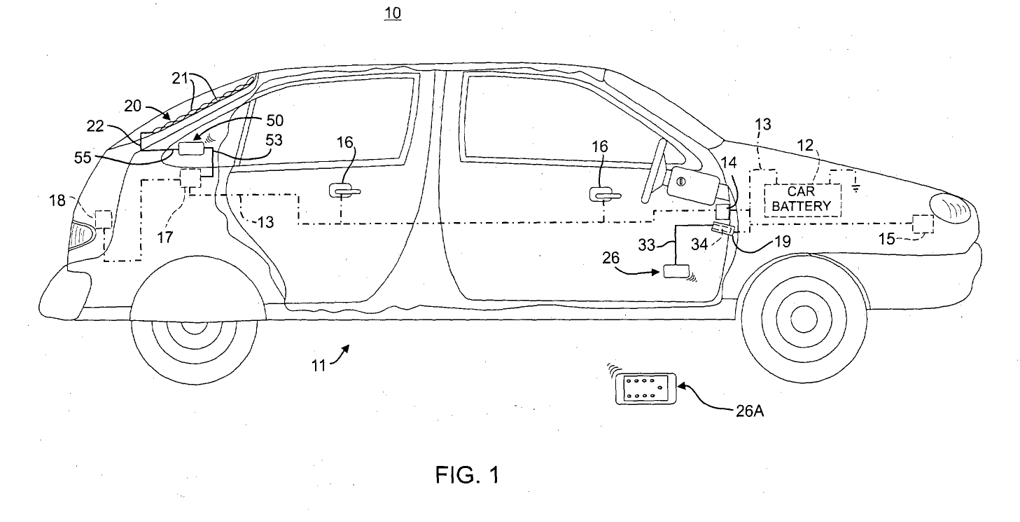

Referring to FIG. 1, there is illustrated an automotive vehicle, generally designated by the numeral 10, of a type with which the control system described herein may be used. The vehicle 10 is illustrated in the form of a sedan-style vehicle, but it will be appreciated that it could be any type of automotive vehicle. The vehicle 10 has a chassis 11 and will typically be provided with a self-propulsion unit, such as an internal combustion engine (not shown). The vehicle has an electrical system powered by an onboard battery 12, which may be a 12-volt, lead-acid battery, and is typically located in the engine compartment, which may be at the forward end of the vehicle. The battery 12 is connected by electrical circuitry, including wiring 13, to a plurality of locations in the vehicle at which are disposed various devices adapted to be powered from a 12 VDC supply. Thus, for example, the battery voltage may be connected by the wiring 13 to a dashboard location 14 for powering various switches, a head lamp location 15 for powering head lamps, lights and gauges, two or more window/door locations 16 for powering power windows and door locks, one or more speaker locations 17 for powering audio speakers, a tail light location 18 for powering various vehicle tail lamps, and a cigarette lighter socket 19. These locations are simply set forth by way of illustration, it being appreciated that there may be any number of other devices on the vehicle 10 adapted to be powered by the 12 VDC battery supply. At each of these locations, the wiring 13 carrying the battery voltage is relevantly accessible to a user for purposes of repair, maintenance, part replacement and the like.

The vehicle 10 is also provided with an accessory device, such as an accessory lighting system 20, including a plurality of lights 21 interconnected by wires 22. In the illustrated embodiment, the lighting system 20 is shown as being disposed in the vicinity of the rear window of the vehicle. However, it will be appreciated that such a lighting system could be utilized at any of a number of different locations on the vehicle.

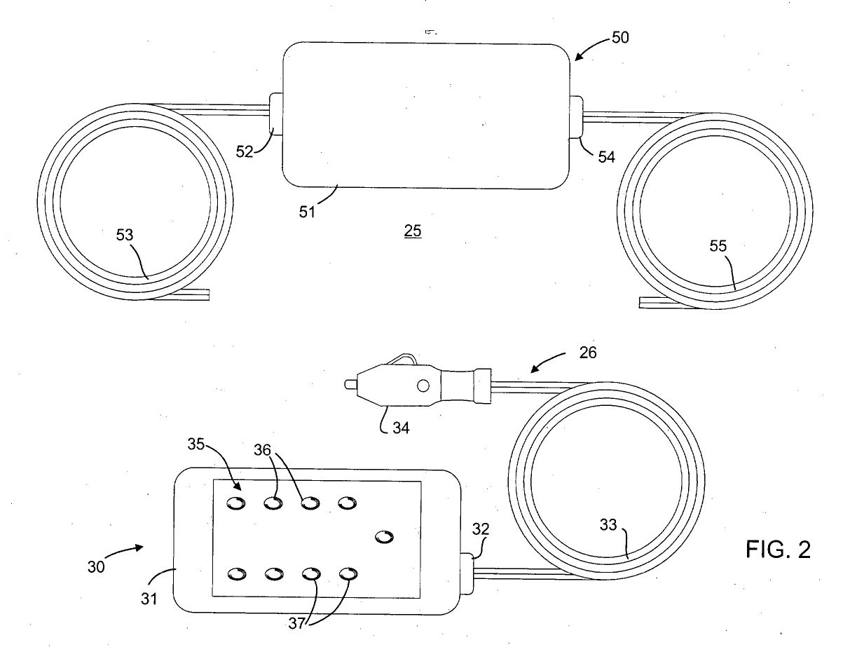

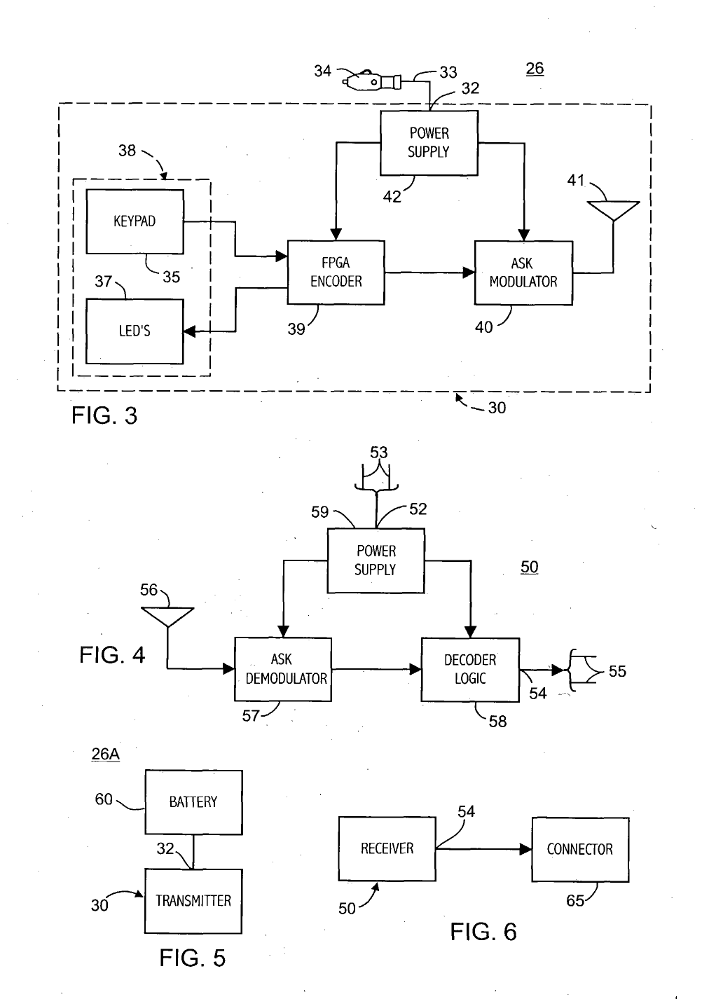

Referring also to FIGS. 2-4, there is provided a control system 25, including a remote control unit 26 and a receiver unit 50, for controlling the operation of the lighting system 20. The remote control unit 26 includes a transmitter 30, which is disposed in a housing 31 provided with a power port 32 connected to one end of an elongated cable, which may include a pair of insulated, electrically conducting wires 33, the opposite ends of which are connected to a cigarette lighter adapter plug 34. Carried by the housing 31 is a key pad 35, which may include a plurality of pushbutton keys 36, as well as a plurality of indicator lights, which may be in the form of LED's 37 respectively associated with the keys 36. Referring to FIG. 3, the key pad 35 and the LED's 37 cooperate to form a user interface 38, which are connected to an encoder 39, which may be a field programmable gate array (“FPGA”), which is a logic device utilized to monitor the inputs from the key pad 35 and to control the operation of the LED's. When a key is depressed, the encoder 39 generates a unique address corresponding to the key, which is then sent to a modulator 40, which may be an amplitude shift keying (“ASK”) modulator, which modulates the encoded signals onto a suitable carrier wave for wireless transmission from an antenna 41. The transmitter 30 is also provided with a suitable power supply 42, which is connected to the power port 32 for receiving 12 VDC power through the cigarette lighter adapter plug 34, the power supply 42 generating the necessary DC voltages for powering the encoder 39 and the modulator 40. While an RF transmitter is illustrated, it will be appreciated that wireless transmission could also be effected at other wavelengths, such as infrared by the use of an IR source for line-of-sight transmission.

The receiver unit 50 has a housing 51 provided with a power port 52 connected to one end of a cable, which may include a pair of insulated, electrically conductive power wires 53, and is also provided with a control port 54, connected to one end of a cable, which may include a pair of insulated, electrically conductive control wires 55. Referring to FIG. 4, the receiving unit 50 also includes a receiving antenna 56, which is connected to a demodulator 57, which may be an ASK demodulator, for receiving and demodulating signals transmitted from the remote control unit 26. The demodulated signals are supplied to decoder logic 58 for decoding the address signals, which are then supplied to the control port 54 for delivery to the wires 55. The receiver unit 50 includes a power supply 59 connected to the power port 52 and providing the necessary DC supply voltages for powering the demodulator 57 and the decoder logic 58. receiver unit 50 includes a power supply 59 connected to the power port 52 and providing the necessary DC supply voltages for powering the demodulator 57 and the decoder logic 58.

In operation, the wires 53 of the receiver unit are connected to the onboard 12 VDC supply at a conveniently located one of the remote locations 14-19 on the vehicle. In the illustrated embodiment, the receiver unit 50 is connected to the 12 VDC supply at the location 17. This connection may be effected by simply splicing the power wires 53 to the 12 VDC wiring 13 at that location, in a known manner. The receiving unit 50 is then connected to the lighting system 20 by connecting the control wires 55 to the lighting system wires 22, which connection may again be effected by splicing. Thus, no wires need be strung from the lighting system 20 to the dashboard or any other position in the passenger compartment convenient to the driver.

Instead, the remote control unit 26 is powered by plugging the cigarette lighter adapter plug 34 into the cigarette lighter socket 19, in a known manner. Then, the driver can control the lighting system 20 by operating the key pad 35 of the remote control unit 26. More specifically, in order to turn on the lighting system 20, the user will operate one or more of the keys 36 to generate a corresponding code, which will then be wireless transmitted from the transmitter 30 to the receiver unit 50, which will decode the signals to actuate the lighting system 20. Turning off of the lighting system 20 can be effected in a similar manner. When a key on the key pad 35 is actuated, the LED's may be triggered on to signify that the remote control unit 26 is in operation. The LED's 37 may or may not be associated with specific keys of the key pad 35, and they may serve simply decorative purposes.

It will be appreciated that the control system 20 is user programmable via the keypad 35, so that the user can select a code to correspond to the particular lighting system 20 or other device to be controlled. A significant aspect of the control system 25 is that it can be utilized to control more than one lighting system or other accessory device, limited only by the number of codes which can be generated by the key pad 35. It is also possible to control individual lighting systems separately or in combinations, and in accordance with predetermined patterns or sequences.

While the remote control unit 26 is adapted to be powered from the vehicle cigarette lighter, it will be appreciated that it could be independently powered. Referring to FIG. 5, there is illustrated an alternative embodiment of remote control unit, generally designated 26A, which is substantially identical to the remote control unit 26, except that, in this case, the power port 32 of the transmitter 30 is connected to a local battery 60 for providing the power to the power supply 42, the battery 60 being disposed within the housing 31. The remote control unit 26A may be similar in size to the remote control units utilized for keyless entry of automotive vehicles. Thus, it will be appreciated that, by use of the remote control unit 26A, the accessory lighting system 20 can be controlled from outside the vehicle.

While, in the illustrated embodiment, the receiver unit 50 is adapted to be spliced to the wiring of the lighting system 20, it will be appreciated that the lighting system 20 could be provided with an electrical connector. In that case, the receiver unit 50 may have the control port 54 thereof connected to a suitable connector 65 for mateable connection with the connector of the lighting system 20.

From the foregoing, it can be seen that there has been provided an improved control system and method for remotely controlling an accessory vehicle lighting system or other accessory apparatus, without requiring the stringing of any wiring between the accessory device and the dashboard or other location readily accessible to the driver, and without requiring the wiring of any switches. The system and method also permit the controlling of multiple accessory systems or devices.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A control system for use with a vehicle, which vehicle has an onboard battery and circuitry delivering battery voltage to plural remote onboard access locations on the vehicle remote from the battery, at which locations battery voltage is accessible, the system comprising:
a portable wireless remote control unit including circuitry for generating and transmitting wireless control signals, and
a portable wireless receiving unit for receiving wireless control signals and generating output signals,
the receiving unit including a power input lead adapted to be connected to battery voltage at any of the access locations on the vehicle and a control output lead for connecting the output signals to an associated apparatus to be controlled.

2. The system of claim 1, wherein the remote control unit includes circuitry for encoding the control signals and the receiving unit includes circuitry for decoding the control signals.

3. The system of claim 1, wherein the remote control unit includes a user interface.

4. The system of claim 3, wherein the user interface includes a keypad.

5. The system of claim 3, wherein the user interface includes visible indicators.

6. The system of claim 1, wherein the remote control unit includes a connector plug adapter for connection in a vehicle cigarette lighter socket.

7. The system of claim 1, wherein the remote control unit includes a battery.

8. The system of claim 1, wherein the receiving unit includes a connector on the control output lead adapted for connection to the associated apparatus to be controlled.

9. The system of claim 1, wherein the remote control unit includes a programmable control circuit.

10. A method of controlling a device on a vehicle, which vehicle has an onboard battery and circuitry delivering battery voltage to plural access locations on the vehicle remote from the battery, at which locations battery voltage is accessible, the method comprising:
providing a portable wireless remote control transmitting unit and a portable wireless receiving unit,
connecting the receiving unit to battery voltage at an access location on the vehicle close to that at which the device is to be disposed,
connecting the receiving unit to the device, and
transmitting wireless control signals from the transmitting unit to the receiving unit.

11. The method of claim 10, wherein the step of connecting the receiving unit to battery voltage includes providing a power input lead on the receiving unit and splicing it to the vehicle circuitry at the access location.

12. The method of claim 10, wherein the step of connecting the receiving unit to the device includes providing a control output lead on the receiving unit with a connector adapted for connection to a mating connector on the device.

13. The method of claim 10, wherein the step of transmitting wireless control signals includes selecting an operating pattern for the device.

14. The method of claim 10, and further comprising connecting the remote control transmitting unit to the vehicle battery.

15. The method of claim 14, and further comprising providing a plug connector on the remote control transmitting unit adapted for plugging into a cigarette lighter socket on the vehicle.

16. The method of claim 10, and further comprising providing the remote control transmitting unit with its own battery.

17. The method of claim 10, wherein the device controlled is a decorative accessory lighting system.
